(19) United States
(12) Patent Application Publication
(10) Pub. No.: US 2005/0177459 A1
(43) Pub. Date: Aug. 11, 2005

(54) System for utilizing information carriers in commercially used facilities

(76) Inventors: Wolfgang Kratzenberg, Schauenburg (DE); Siegfried Stein, Vellmar (DE)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 10/511,948

(22) PCT Filed: Mar. 27, 2003
(86) PCT No.: PCT/EP03/03162

(30) Foreign Application Priority Data
Apr. 23, 2002 (DE) 102 18 168.3
Apr. 27, 2002 (DE) 102 18 967.6

(51) Int. Cl. G06F 17/60

(52) U.S. Cl. 705/27

(57) ABSTRACT

Disclosed is a system for utilizing existing information carriers used for advertising purposes or for directing traffic in shopping centers, leisure facilities and similar commercially used facilities which comprise goods stores and possibly restaurants or similar supply structures that are accessible and connected to each other via corridors and in which facility-owned means of transport (2) are made available to the public for transporting purchases and/or other objects. A plurality of information carriers is disposed across the surface area of the commercially used facility. A triggering device issuing at least one, preferably a number of different advertisements is assigned to said information carriers in addition to a triggering device issuing a standard message. The triggering device of the information carriers (7) can be switched over by means of sensors, each of which emits a signal that is characteristic of a specific transport vehicle.

The invention relates to a system for utilizing information carriers in commercially used facilities, such as shopping centers or leisure centers and the like, having a number of goods stores and possibly restaurants and the like interconnected with each other through corridors. Supply structures and a number of more or less centrally arranged payment stations as well as direction sign-postings using information boards and further equipment using information carriers conveying literal, graphic and/or acoustic promotional messages, whereby carts or other means of transporting offers are offered to the shoppers for transporting their shopping and/or other items at least within the commercially used facility.

In a facility accessed by the public, in which goods or services are offered to the public or even supply services are offered there are usually information carriers present, by means of which the public is informed about special offers or services. The simplest form of such information carriers are information boards, posters and similar static information. The drawback in this type of information carrier is the circumstance that they are relatively expensive to adapt to the different goods and to momentary and in particular to temporary situations, such as special offers or the like.

Furthermore, it is almost impossible to determine or even to obtain an overview of the advertising efficacy of such static information carriers.

Primarily in shopping centers with a very large offering of the widest variety of goods such as, for example, in supermarkets, the conversion—at least partially—at the storage facilities of using simple information signs such as colored arrows and the like, for example, to direct attention to goods to be promoted or special offers, which has the advantage on the one hand that the signing is reusable and on the other hand that they can be easily converted without intensive labor.

Further, it has already been proposed especially for supermarkets, shopping centers and, if necessary, recreational parks that in lieu of convertible information signs illuminated signing with variable text or graphics be used, wherein the illuminated signing is activated either individually or from a central location of the facility and, if necessary, even provided with alternating, scrolling text or image. Information carrier systems of this type can be adapted at low expense to almost any desired application but address, however, as also in the case of the simple static signing, indiscriminately all persons happening to be in the visual range of the information carrier, so that it is not rare that one and the same person encounters the same image again and again.

The object of the invention, therefore, is to provide a system utilizing information carriers in commercially used facilities such as, for example, shopping centers, supermarkets or even leisure centers and the like, which makes it possible to avoid the prior art systems and further of addressing each person of the public individually, who is accompanied by one of the transport means within the within a facility.

This object is achieved according to the invention essentially in that a number of information carriers are distributed over the area of the commercially used facility, each of which having, in addition to a triggering device for issuing the standard information, a device for triggering the issue of at least one and preferably a number of different advertisements or information items and wherein the triggering of the information carriers can be switched by a signal emitter, which emits a signal that is characteristic for a specific transport cart or another specific transport means. Accordingly, a discrete identity, which cannot be confused by the sensing system, is assigned to each person using transport cart or another transport means provided in the respective facility which results in that the utilization of different information carriers within the facility can be cancelled out for the respective identity; to the effect that, for example, the individual never receives the same information two or more times, unless so planned, as is necessarily the case in all prior art information carriers serving in only one area of the facility.

In the interest of the best possible utilization of the individual information carrier which can be configured using, for example, monitor screens, large displays or beamers in conjunction with special glass panes or other controllable devices for graphic, textual and/or acoustic representations, any existing information carriers that can be switched on and off or triggered within the area of a commercially used facility as a factor of controllable switch-on times of selectable lengths.

In a preferred embodiment, each of the information carriers can be provided with a pre-programmed standard display, possibly as a direction signing and each of the on/off switchable displays that can differ from the standard display relative to a specific emitter can be activated or triggered only once using that mobile signal emitter, so that the display is shown once or in any frequency and/or order to person being treated individually.

In an expedient embodiment of the system for utilizing information carriers, means emitting coded signals, in particular interrogating transponders, are arranged on the transport carts or other transport means, such as shopping carts or the like provided to the shoppers in a commercially used facility, said means emitting a signal characterizing exactly the respective cart or the respective other transport means and is preferably associated with triggering a display differing from a standard display. Particularly in this instance, provision can be made that all information carriers are equipped with a device, especially a transmitting/receiving system, for querying the encoded data of the individual transponder, whereby the transmitting/receiving system directly or indirectly and at least one counting device is switched downstream for acquiring and storing the number of activation signals per unit of time. It is particularly advantageous for other further developments of the system, if provision is made, that in addition to a counter device a time cycling device is arranged downstream to the transmitting/receiving systems, which upon recognition of a static activation signal for a specific advertisement or display either suppresses its repetition of, however, limits it to pre-programmed intervals. Furthermore, a limited switching time or activity period is assigned to each diverging display of a standard display of an information carrier. For using the system according to pre-defined rules; for example, the rule that each activatable display or message should be displayed once or a planned number of times to the person identified by the transmitting/receiving system as an individual it is further advantageous to assign a device to the transmitting/receiving system of each information carrier, which prevents, at least during one display triggered during the run-time by a first signal emitter, the display from being activated again by further signal emitters reaching the transmitting/receiving systems transmission area.

Naturally, in the context of the system for utilizing information carriers other intelligent or connected rules can be provided such as, for example so that the person recognized as an individual is led by multiple—stage information or messages displayed on consecutively triggered information carriers either to specific areas of a facility or, however, to sources of accessories or the like. This is especially provided by the system for utilizing information carriers in that each person is recognized as an individual and therefore his/her location can be determined at any time, so that the person is consequently also treated as an individual.

Within a system for utilizing information carriers the provision of the individual displays or advertising messages to the different information carriers in the simplest scenario can be achieved by means of a wireless remote control or by cable. In this type of decentrally organized system for utilizing information carriers a mini-computer and a programmable memory for a number of different temporarily displays to be temporarily displayed and at least one other temporary memory for collecting statistical data is associated with each information carrier, in addition to its transmitting/receiving system.

In the case of systems for utilizing information carriers for larger facilities it appears more advantageous, however, to provide a central organization with a central computer, which is expediently connected to a the individual information carriers via lines and whose supply with graphic or textual advertising, especially as to the supply or exchange of merely temporarily utilizable displays, because in this fashion a quick exchange of displays or messages is substantially facilitated. Above all, in the case of this type of centrally organized systems for utilizing information carriers the central computer can manage the paid advertising time for each individual information carrier, so that a display is displayed or triggered only for as long as the advertising time is paid for. Furthermore, the central computer for central acquisition and processing of any type of usable statistical data such as, for example, frequency of triggering of the individual information carriers, delimitation of individual areas of the facility, selection of the displays and possibly in conjunction with antennas in the area of scanner cashier stations can be used for the assignment of certain displays for sales of specific goods. In particular, data as to, for example, how many persons identified as individuals stopped during the running time of a display in the acquisition area of the transmitting/receiving system of an information carrier or which periods of time individual persons spent in a specific area of the facility can be acquired.

In the following exemplary description an exemplary application of the system for utilizing information carriers is described in the simplified diagrammatic representation.

In the drawings:

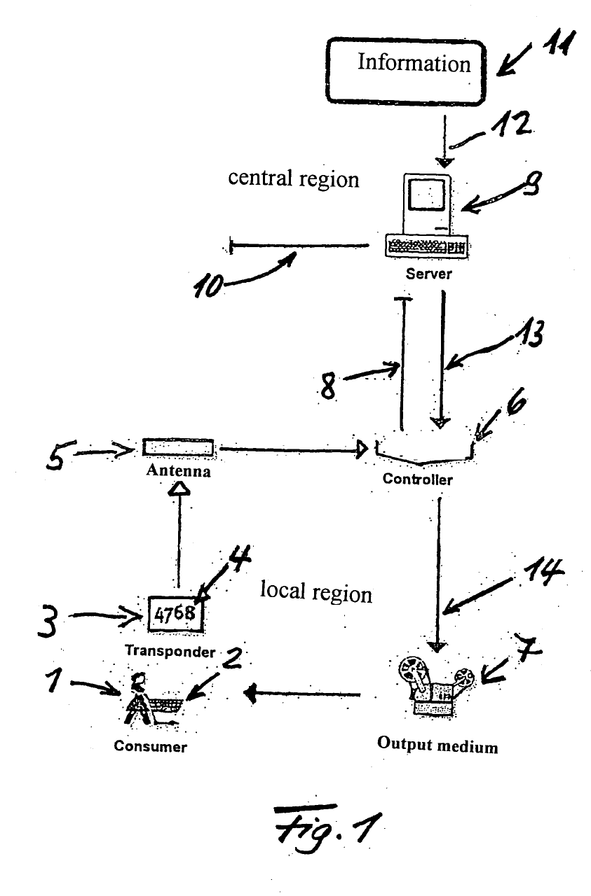

FIG. 1 shows a diagrammatic representation of the technical principle of the system for utilizing information carriers;

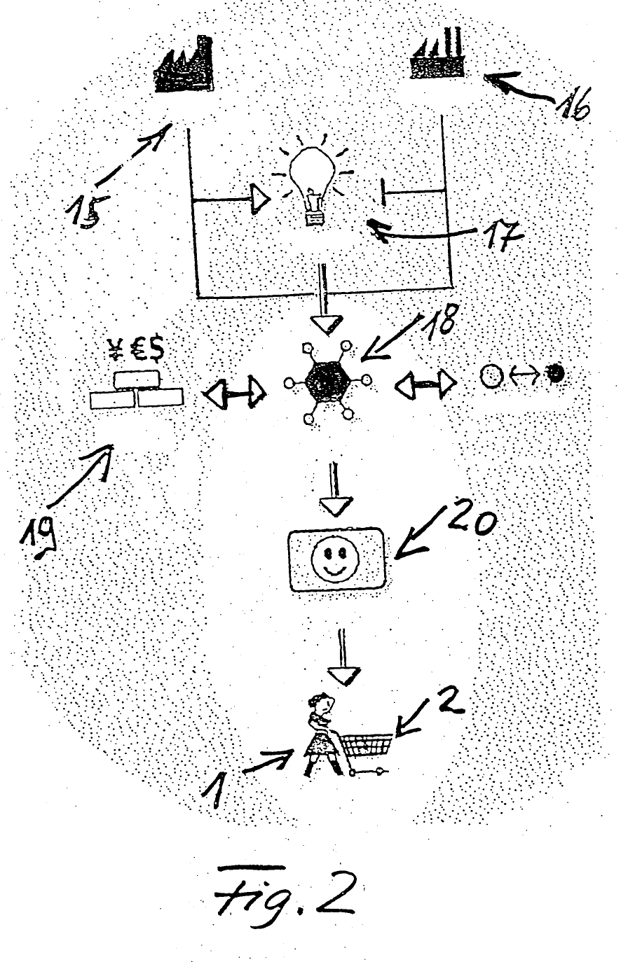

FIG. 2 shows a diagrammatic representation of the organization of a commercial utilization principle of the system for utilizing information carriers.

According to the representation of FIG. 1, a person 1 moving in a facility equipped with a system for utilizing information carriers according to the invention uses a transport cart 2, which is equipped with an identity signal that can be queried; here, a transponder 3 having an identification number 4. Transmitting/receiving systems 5 are distributed over the facility, which have a pre-programmed acquisition range and are assigned to the identification of the transponder 3 acting as the signal emitter. The transmitting/receiving system transfers information such as, for example, the location of the transponder or the person 1 or the time spent by the person 1 in the acquisition area of the transmitting/receiving system 5 to a controller 6, which then triggers the output of a display or message via an associated information carrier 7, so that the person 1 receives transfer of essential information relating to his/her momentary location. At the same time, the controller supplies, via a line 8, all data that can be gleaned from the identification of the transponder 3 and any statistically usable data such as, for example, the time spent, location, number of other transponders situated in the acquisition area of the transmitting/receiving system, to a central computer 9, which in its turn supplies current statistical data to an information pool, to interested parties, in particular the advertisers, product manufacturers in addition to the facility operation and the like with On the other hand, representations of information, texts or images or the like 11 produced by advertising specialists can be entered using the central computer can be fed into the central computer via lines 12 and issued by it via a further line 13 to the controller 6 and from it ultimately via a further line 14 to the information carrier 7.

According to the representation shown in FIG. 2, a number of main suppliers 15, in particular the manufacturers of goods and supplier 16; for example, also service providers, an advertising agency 17 provide an operator 18 of the central computer 9 prepared texts or images for display or advertising messages. At the same time a first supplier 19 of a facility—a supermarket 20, for example—provides transport means equipped, for example, with carts 2 equipped with transponders 3, while a second supplier provides the required information carriers 7, transmitting/receiving systems 5, computers and the like.

In an overview, it can also be provided that at least one superordinate administration computer is assigned to the central computers assigned to a more or less optional number of facilities and using the superordinate computer, for example, the capacity utilization of the different information carriers can be optimized with advertiser displays and using this a higher level acquisition of statistical data and the like, overall management tasks such as, for example, the management of advertising contracts can be concluded for a relatively large area. In particular, using the superordinate computer a selection can be made, as to in which facilities at which time which advertising messages are transmitted.

1. A system for utilizing information carriers in commercially used facilities such as, for example, shopping centers, leisure facilities and the like, having a number of goods stores and possibly restaurants of similar supply structures reachable via corridors connecting them with each other and a number of more or less centrally arranged payment cashier stations and a sign-posting system using information boards and further a system of information carriers conveying textual, graphic and/or acoustic advertising or other messages, whereby the shoppers are offered carts or other transport means for transporting their purchases and/or other items at least within the commercially used facility
characterized in that
a number of information carriers is arranged over the floor space of the commercially used facility and said information carriers, to which, along with triggering for outputting a standard display, a device for triggering for outputting at least one, preferably a number of different advertising displays is associated and wherein the triggering of the information carriers can be switched by signal emitters, each of which emit a signal that is characteristic for a specific transport cart.

2. The system for utilizing information carriers according to claim 1, wherein a switch-on time of selectable magnitude is assigned to the information carriers are generally present that can be switched on/off or triggered within the area of the commercially used facility.

3. A system for utilizing information carriers according to claim 1, wherein each of the displays that can be switched on and off and deviating from a standard display of an information carrier relative to a specific signal transmitter can be activated or triggered once or according to special pre-programming several times or in multiple arrangement via said signal transmitter.

4. The system for utilizing signal carriers according to claim 1, wherein transmitting systems are provided in the area behind the exit or in front of the entrance of each facility, said transmitting systems resets the means emitting the encoded signals, in particular the interrogating transponder, so that each transponder represents its own new, discrete identity upon entering the facility.

5. The system utilizing information carriers according to claim 1, wherein means emitting coded signals, in particular a interrogating transponder, is arranged on the transport carts provided for the use of the shoppers in the commercially used facility, said means emitting a signal that is characteristic exactly for said cart and is associated preferably with triggering a display that deviates from a standard display.

6. The system utilizing information carriers according to claim 1, wherein all information carriers are equipped at least with a device suitable for querying the coded data of the individual transponders, in particular a transmitting/receiving system.

7. The system utilizing information carriers according to claim 1, wherein at least one counter device for acquisition and storing of the number of activation signals per unit of time is arranged downstream to the transmitting/receiving system,

8. The system utilizing information carriers according to claim 1, wherein in addition to a counter device, a time cycle device is arranged downstream of the transmitting/receiving systems, which upon identifying a static activation signal for a specific advertising message, whose repetition is limited to pre-defined intervals.

9. The system utilizing information carriers according to claim 1, wherein the information carriers are programmed with a standing advertising message, which autonomously switches on, if there is no activating signal for a triggerable advertising message.

10. The system utilizing information carriers according to claim 1, wherein each display deviating from a standard display of an information carrier is assigned a limited switch-on time.

11. The system utilizing information carriers according to claim 1, wherein the transmitting/receiving system of each information carrier is associated with a device, which prevents that during a running time a triggered is not activated again by other signal emitters entering the transmitting area of the transmitting/receiving system.

12. The system utilizing information carriers according to claim 1, wherein the provision of the different advertising messages or displays on the individual information carriers is done by means of a wireless remote control system.

13. The system utilizing information carriers according to claim 1, wherein in a centrally organized system utilizing information carriers is associated with a central computer for supplying the individual information carriers with displays, in particular temporary displays.

14. The system utilizing information carriers according to one of claim 1, wherein in the case of a centrally organized system for utilizing information carriers the central computer manages the paid advertising time in such a fashion that each display is display for only so long as the advertising time is paid for and that all static data such as the frequency of triggering of the individual information carriers, the delimitation of the individual areas of the facility, the selection of the displays and in connection with antennas in the area of scanner cashier stations the association of the displays with sales of specific goods, are likewise processed in the central computer.

15. The system for utilizing information carriers according to one of claim 1, wherein in the case of a decentrally organized system for utilizing information carriers a mini-computer and a programmable memory for a number of different temporarily displayed displays and at least one further memory for collecting statistical data are associated with each of the information carriers, along with its transmitting/receiving system.

16. The system utilizing information carriers according to one of claim 1, wherein at least one superordinate management computer is associated with the computers associated with a more-or-less optional number of systems.
